(19) United States
(12) Patent Application Publication
(10) Pub. No.: US 2011/0309212 A1
(43) Pub. Date: Dec. 22, 2011

(54) Wrist rest

(76) Inventors: Salvatore Guerrieri, New York, NY (US); Christopher C. Papadopoullos, East Northport, NY (US)

(21) Appl. No.: 11/117,015

(22) Filed: Apr. 28, 2005

(51) Int. Cl. A61H 99/00; H05B 3/02; A47G 29/00

(52) U.S. Cl. 248/118; 219/529; 219/482

(57) ABSTRACT

The present invention provides an orthopedic wrist rest where accessories and extensions are reversibly attached, to provide heat, vibration, or structural aspects as light, fans or ionizers.

### FIELD OF THE INVENTION

The present invention pertains to a keyboard and mouse pad wrist rest, and more specifically to an orthopedic wrist rest of varied functionality.

### BACKGROUND OF THE INVENTION

With the advent of the personal computer and the legion hours that people spend in front of the machines for word processing, creating spreadsheets, inventory control or a myriad of other tasks there has been a rise in injuries related to the use of the keyboard and mouse. One such injury that is prevalent is carpal tunnel syndrome and other diseases which are exacerbated are the arthritis-type and joint disorders. Carpal tunnel syndrome and repetitive stress injuries arise from the use of a keyboard either alone or in conjunction with a mouse. To this end there have been many pads that are interposed to provide a soft or cushioned purchase point. There are several keyboards and trackball pointers that have been constructed to obviate injury and increase ease of use or comfort. For example, the ergonomic keyboard is but one assembly that is designed to more naturally conform hand placement to typing posture.

There are many cushions and rests available at the local office supply store. Most rests, whether fashioned from gel or open/closed cell sponge polymer suffer from a similar problem. Rests are difficult to place, do not remain stable or immovable, and generally fail to provide other utility.

It has been found that ergonomic-shaped wrests may be fashioned from a gel material. Gels are formed from a variety of substances, and many can be a simple mixture of a carboxymethylcellulose, water and a preservative or a more esoteric co-polymer and oil compound. While gels are one conformable material, others include sand, glass marbles, plastic beads, wood pieces, bearings and the like.

### PRIOR ART

There are a number of pads and rests that elevate and cushion the user's wrist. A series of rests that incorporate a solid foam or gel is the most common form of the product and can be found in most office supply stores. As a rule the rest is either of a flat or pillow-shaped conformation. There are a number of shortcomings inherent in prior art wrist rests. For example, flat rests dispose the typist's hand and wrist at a less than optimal angle for prevention of repetitive stress injuries. In addition, the use of gel and like substances often result in a rest that is simply too heavy to be practicable. Other rests are rigid and provide support for some but not all users. Still others have rolling ball members or contoured surfaces. The patent art reveals a number of patents as follows:

The prior is rife with examples of adjustable gel wrist rests. For example, the “Fellowes Adjustable Gel Wrist Rest, Safco Vantage Economy Keyboard Wrist Rest, Staples Gel Wrist Rest, Acco Wrist Pillow Gel Platform, Acco Wrist Pillow Gel Extended Platform, and Safco Proline,” all sold by Staples provide a simple gel filled wrist rest, without any further utility power or the like. The sheer variety of designs of wrist rests never ceases. For example, there is a series of rests that utilizes rotating spheres to comfort and massage the user. Not to be outdone the number of wrist rests for use with a mouse pad is legion. For example, one company Belkin merchandises a number of rests including ergonomic rests and wrist rests like those named Ergo Pad and Waverest

The U.S. patent art discloses a wide variety of wrist rests from the fanciful to those of “high tech” description. For example, U.S. Patent number US2005/0029412 A1 relates to a wrist rest of a novelty shape.

U.S. Pat. No. 6,644,605 issued to Tyner discloses a computer keyboard tray that retains the keyboard and mouse, while providing for a wrist rest and mouse pad.

U.S. Patent issued to Wolf et al, 6,626,403 B1 pertains to a wrist rest assembly that provides a base and rest that is situated on top of the base. The rest is constructed from gel, and is remarkable only in that it appertains to the elongated gel rest in conjunction with a base. While U.S. Patent 2002/0166927 A1 as well centers more on the construction of a platform for both wrist rest and keyboard.

There are a number of wrist rests that fit within the case of a laptop. For example, the Integrated Wrist Rest of U.S. Pat. No. 6,216,988 B1 discloses a rest that is assembled into the chassis of a laptop computer.

While some of the rests have a gel others like U.S. Pat. No. 5,980,143 issued to Bayer, et al, utilizes a copolymer web, while Wrist Rest Assembly of patent number WO 98/08420 discloses a construction for making the resulting rest of a manageable weight by utilizing a sponge-like polymer layer within the gel.

The Wrist Rest of U.S. Pat. Nos. 5,628,483 and 5,197,699 issued to Smith et al discloses a rest with an interlocking pad that extends the rest to cover the length of the keyboard and mouse pad. The variety continues in U.S. Pat. No. 5,601,264 issued to Peart wherein there are inflatable bladders that cushion the user's wrist or U.S. Pat. No. 5,566,913 issued to Prokop which discloses a gel that may be heated or cooled externally and in a manual manner, the heating and cooling are of an ephemeral nature.

### OBJECTS OF THE INVENTION

The principal object of the instant invention is to provide a wrist rest for use with a personal computer keyboard and/or mouse-pad that is, ergonomic and orthopedic in nature.

Another object of the invention is to provide a conformable wrist rest that is ergonomic and therapeutic in reducing such repetitive stress injuries as carpal tunnel syndrome.

Yet another object of the present invention is to provide a wrist rest that provides a number of other utilities like heat, vibration, air purification and/or a structural element to hold something like a coffee cup.

Another object of the instant invention is to provide a series of attachable elements so that the wrist rest and accoutrements are detachable and may be combined as a snap-together assembly by attachment.

Yet another object of the present invention is to provide a wrist rest that may be constructed as integral, all pieces being of a single construction or through the use of inter-connecting pieces with power flowing therethrough.

Still another object of the instant invention is to provide communication between the user, a personal computer and the wrist rest through a controller means and computer software.

### SUMMARY OF THE INVENTION

The present invention provides a wrist rest for a computer keyboard and/or mouse pad. The wrist rest is constructed to include a cushioned area as an elongated member, with said cushioned area being fashioned as a wrist rest and is filled with a material conformable to one's hand and wrist. The elongated area is raised and gently contoured to provide optimal support and purchase for using both the keyboard and the mouse pad. While the rest may be of one piece, the present invention may include a wrist rest cradled in a base. Within the wrist rest further utility is provided to include a heating source and/or a vibratory means. It is so provided that an energy source may be derived from either a low voltage power source either within the computer system or without as in the case of a battery. While the assembly may be integral and constructed from one piece, it may also be constructed to include disparate parts with reversibly attaching connectors. It should be understood that the connectors may be operatively utilized as a power transmission means for powered peripheral attachments. Therefore, in one embodiment there may be a keyboard with a polymer first section and second section cooperating to form an opening. A conformable material like a gel mix is operatively instilled into the open end, and said open end is sealed to create a cushion assembly. For the mouse pad, a connection with the keyboard is not necessary. A series of leads which is disposed withon the cradle or within the conformable materials may be used to power a heating means, a vibratory motor, fan or an air purifier. A cradle or base foundation is disposed so that a connection with a power source, like a battery or a USB port will yield a small amount of electricity and will power the utilities or slightly warm a gel or the user's wrist. The wrist rest may be fashioned from a single material or obtain to a skin covering a conformable mixture.

The wrist rest for a keyboard or mouse pad may be integral or may be one of several inter-fitting pieces that reversible connect each component. The components snap or may be pressed together through a series of reversible attachment members.

### BRIEF DESCRIPTION OF THE DRAWINGS

It should be understood, by one skilled in the art, that the drawings depict certain embodiments of the invention and therefore are not to be considered a limitation in the scope of the instant invention, but that these and other advantages of the present invention will be more fully understood by reference to the following detailed description when read in conjunction with the attached drawings in which:

FIG. 1 is an elevational view in perspective of a wrist rest for a keyboard and mouse pad, showing an elongated wrist rest in dotted lines;

FIG. 2 is an elevational view thereof, showing the relative heights of the wrist rest in view of the mouse pad;

FIG. 3 is a side view thereof;

FIG. 4 is an elevational view in perspective of a wrist rest for a keyboard and mouse pad, showing an embodiment configured as one one-piece;

FIG. 5 is an elevational view thereof;

FIG. 6 is an elevational view showing a two piece construction thereof;

FIG. 7 is a side view thereof;

FIG. 8 is a side view as a two piece construction thereof;

FIG. 9 is an elevational view of a one piece construction;

FIG. 10 is a rear elevational view thereof;

FIG. 11 is a front elevational view thereof

FIG. 12 is a side elevational view thereof, both sides being the same;

FIG. 13 is an alternate side view thereof, showing a two piece construction, both sides being the same;

FIG. 14 is an elevational view thereof in perspective, showing a one piece construction for a laptop;

FIG. 15 is a front view thereof, showing a one piece construction for a laptop having a separate mouse pad;

FIG. 16 is a front view thereof showing a two piece construction for a laptop having a separate mouse pad;

FIG. 17 is a side view of a one piece construction thereof, both sides being the same;

FIG. 18 is a side view of a two piece construction thereof for a laptop with a separate mouse pad;

FIG. 19 is an elevational view in perspective thereof, adapted with an integral mouse pad and holder with a dotted line depicting a connection;

FIG. 20 is a front view in perspective thereof, adapted with an integral mouse pad and holder with a dotted line depicting a connection;

FIG. 21 is a front view in perspective thereof, of two piece construction, adapted with a mouse pad and holder, with a dotted line depicting a connection

FIG. 22 is a side view of FIG. 20;

FIG. 23 is a side view of FIG. 21;

FIG. 24 is an exploded view showing an attachment means and its mating area within wrist rest;

FIG. 25 is a front view in perspective thereof, having an integral mouse pad and air purifier;

FIG. 26 is a front view in perspective thereof, having an integral mouse pad and air purifier and one piece construction;

FIG. 27 is a front view in perspective thereof, having an integral mouse pad and air purifier and two piece construction

FIG. 28 is a side view of FIG. 26;

FIG. 29 is a side view of FIG. 27;

FIG. 30 is a sectional view of the wrist rest;

FIG. 31 is a sectional view taken along lines 31-31 of FIG. 30;

FIG. 32 is a sectional view of cradle and wrist rest showing a heating coil, and vibrator unit;

FIG. 33 is a sectional view thereof showing a heating member including positive and negative leads and remote power source; and

FIG. 34 is a sectional view taken along lines 31-31 of FIG. 30 including positive and negative leads and remote power source; and

FIG. 35 is a sectional view taken along lines 31-31 of FIG. 30 showing the plurality of vibration reducing footings for the wrist rest.

### DETAILED DESCRIPTION OF THE PREFERRED EMBODIMENT

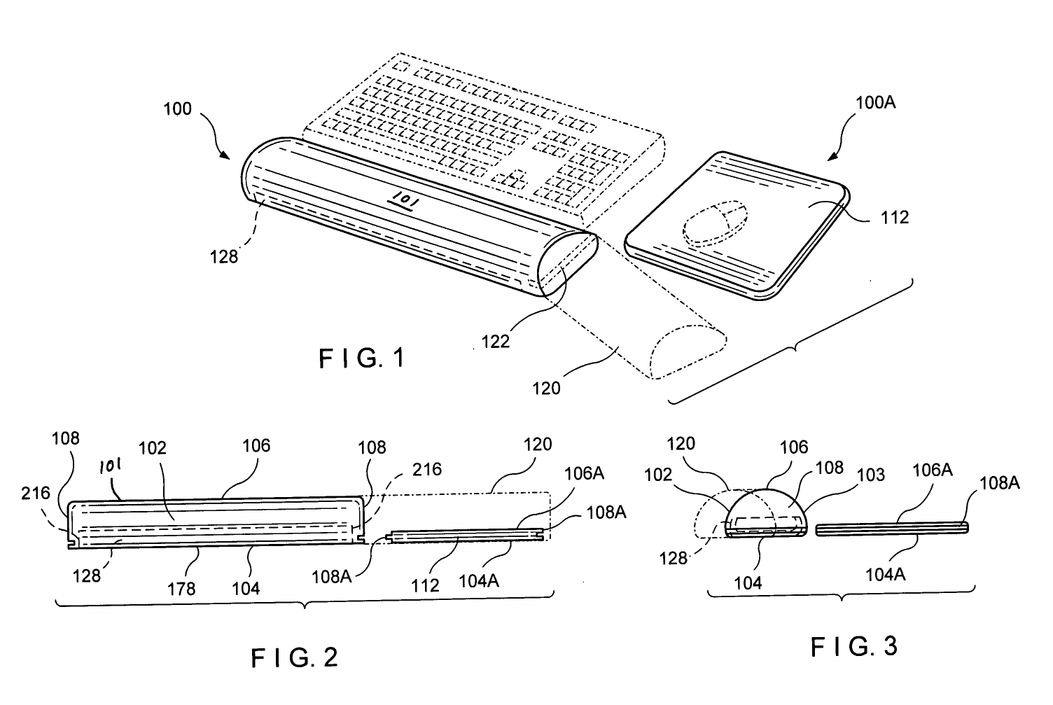

Turning now to the drawings, wherein like numbers refer to like parts throughout, numeral 100 generally depicts a wrist rest for a keyboard and mouse-pad. In its most simplistic embodiment, and in accordance with FIG. 1, wrist rest 100 is of sufficient length to provide a continuous conformable surface with a keyboard or a keyboard and mouse pad for a personal computer. Wrist rest 100 is further constructed to include an elongated member 101 that is dimensionally similar to the keyboard and mouse-pad. As an extension 120 in dotted lines wrist rest 100 may be of variable length and joining or extending from elongated member 101 by extension piece 122. For purposes of this invention wrist rest 100 is mainly defined by elongated member 101, which is constructed from a conformable material as set out herein. The length of wrist rest 100 may be extended as 100A to include sufficient length to include the mouse pad area and thereby enabling the user to enjoy an orthopedic and ergonomically correct rest. Notwithstanding the foregoing, it is generally conceded that the preferred dimensions for the instant invention are from about 19 inches to about 30 inches long, from about 3 inches to about 6 inches wide, and from 1 inch to about 4 inches high. Most appropriately, basic wrist rest 100 dimensionally exceeds the length of the keyboard and mouse pad. A foundation is provided by cradle base 128, and adapted to retain wrist rest 100. It should be noted that while one embodiment would be cradle base 172 being a separate assembly, another would be for the base to be integral and formed in conjunction therewith.

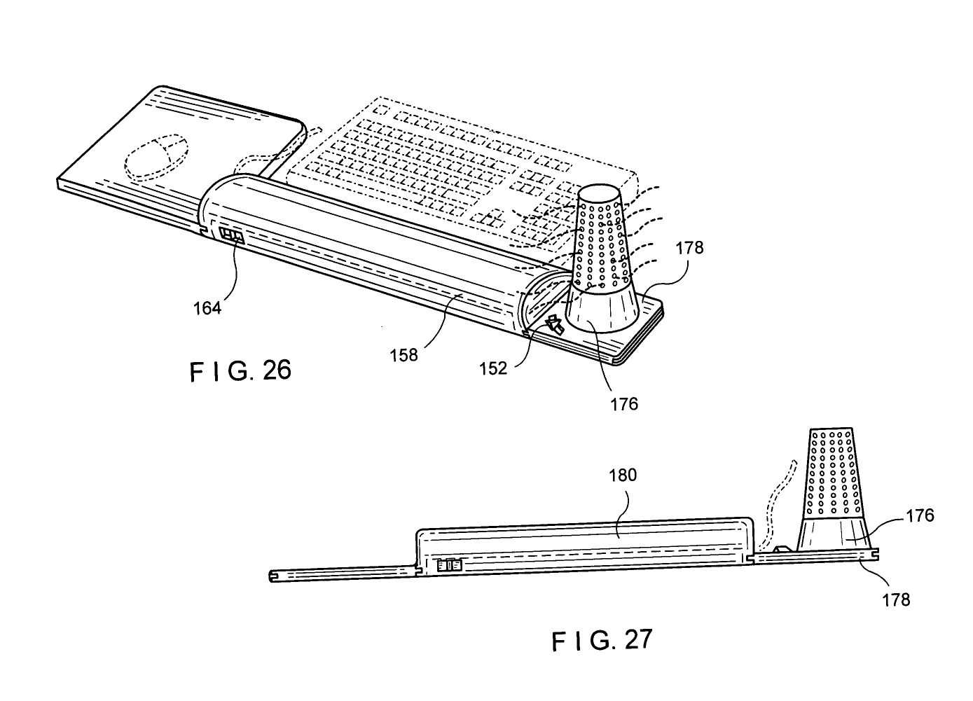

FIGS. 2, 4 and 5 present a most notable aspect of wrist rest 100, which resides in its being amenable to press or snap together assembly. Given this utility, simple things, like positioning the mouse pad on the left side, as shown by FIG. 26 may be easily achieved. In accordance with FIGS. 2, 4, 5, 6, 26, and more specifically 27, each end of cradle base 128 may be configured to terminate in an attachment means 116/118 so that a variety of accessories may be reversible attached to said cradle base 128. Cradle base 128, whether integral or constructed from disparate members is preferably from about 0.5 inches in height to about 4 inches in height so that an area of rest 100 exceeds the highest point of cradle base 128 by the same amount that is retained by cradle base 128. Cradle base 128, receives elongated member 101 thereon. Hence, elongated member 101, may be fashioned as an integral member, an encapsulated gel, a flexible container adapted to receive conformable material, a skin retaining a conformable material or other configurations may be operatively substituted and fall within the scope hereof.

In accordance with FIGS. 2 and 3 show, as an alternate embodiment that cradle base 128 may be constructed as an integral series of molded or otherwise formed areas, constructed to include at least an elongated base member 178 with at least two upstanding sides 216. While cradle base 128 can be of one piece, with all sides being integral, alternately it could be constructed to include a bottom, sides, front and rear side forming an open top portion. Tubular struts and the use of lightweight materials augment the overall construction of cradle base 128 in this alternate embodiment.

Without regard to weight, elongated member 101 of FIG. 1 can be fashioned from a solid polymer or copolymer, alone or in combination with any weight saving material(s). Elongated member 101, when adapted to be disposed within cradle base 128 can be removable so as to provide the user with a variety of different density and or materials comprising wrist rest 100. For example, the use of a large pore closed cell polymer disposed within a sealed hydrophobic polymer bag system would lessen the weight, as would the inclusion of an air bladder or sealed tube while the density of the gel would provide differences in resistance and hardness/softness.

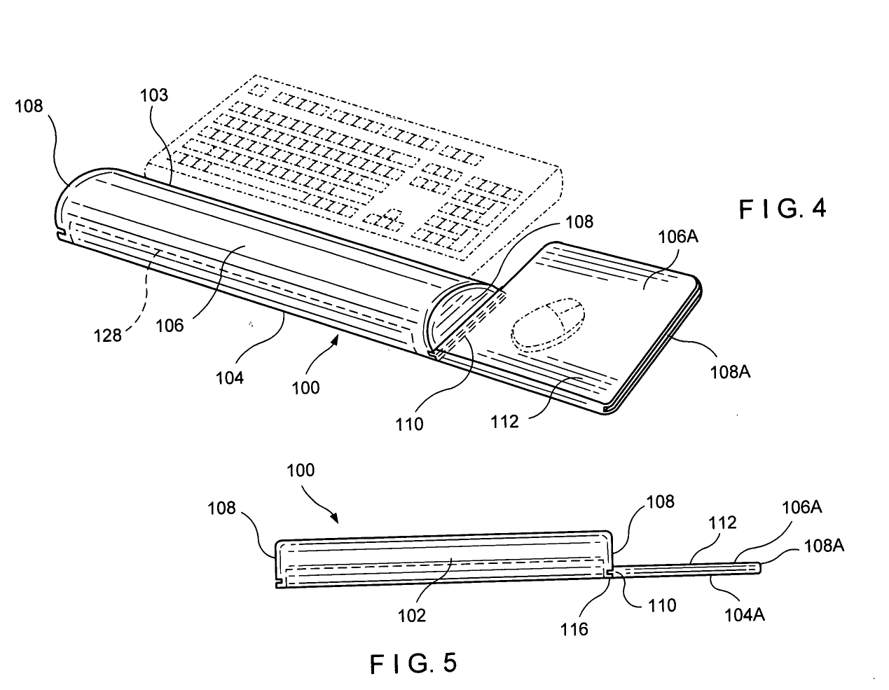

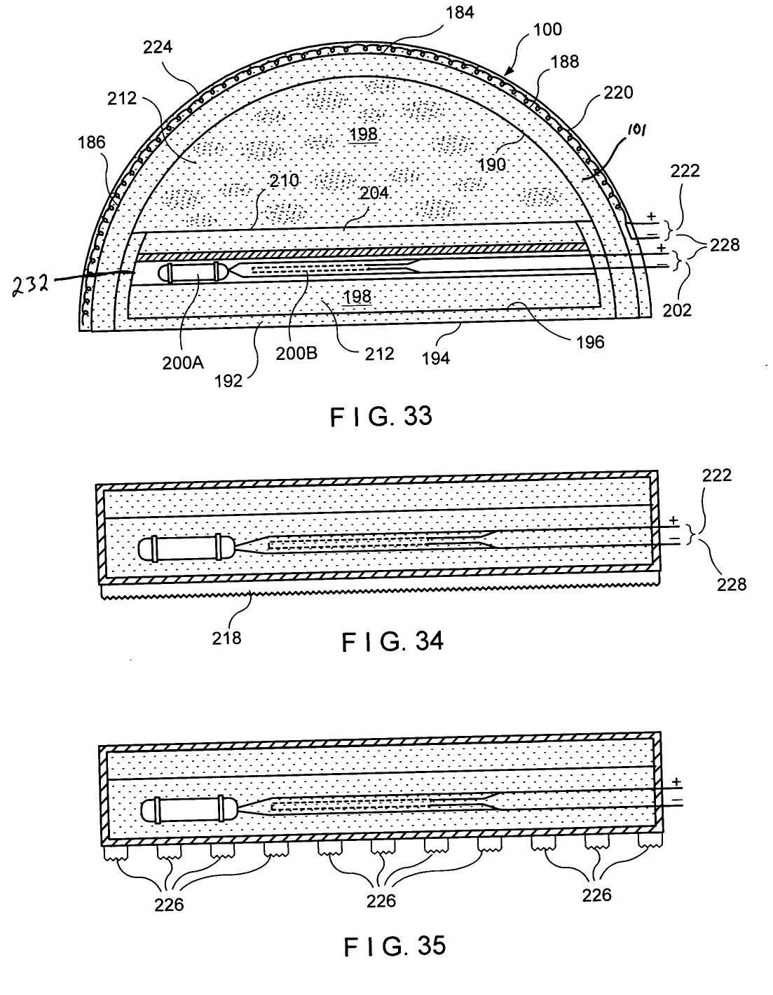

FIG. 4 and FIG. 33 and number 212 depict a conformable material which for purposes of the instant invention is preferably gel 212. It should be noted that a conformable material may be substituted without altering or straying from the metes and bounds of this disclosure. For example, polymer balls, charcoal spheres, wood pellets, sand, sterilized organic material like rice grains, deformable polymer foams, sponges (either dry or encapsulated with an aqueous media), saline gel, vitreous spheres, or metallic spheres/pellets. Membrane or skin 208/210, in accordance with FIG. 33, may be operatively employed to retain the conformable material within a desired boundary of wrist rest 100. The membrane may be a polymer like polyvinylchloride, a foamed rubber like neoprene, a fine mesh of nylon or an organic fiber like cotton. The membrane or skin boundary may be integrally formed from the same polymer as the gel component or may be formed with sides and an opening so that the conformable material may be disposed therein. Notwithstanding the conformable material, it is most preferred that it is either inherently anti-bacterial or an anti-bacterial agent is instilled.

As shown by, by FIG. 2 elongated member 101 is constructed to include a bottom 104, a top 106, and at least two sides 108. It is most preferred that wrist rest 100 be constructed from an impermeable, hydrophobic polymer of any one of number of polymers. Referring to the same drawing FIG. 2, it is illustrated the essential dimensional differences between mouse pad 112, having sides 108A, top 106A and a bottom 104A and elongated member 101 having sides 108, top 106 and bottom 104A.

FIG. 3 shows a second dimensional reference wherein mouse pad 112 is contrasted to wrist rest 100. With reference thereto, it can be seen that the height of the wrist rest is substantially higher than mouse pad 112. It may also be observed that bottom 104, nesting or integral with cradle base 128 is of a flattened conformation as is bottom 104A of mouse pad 112.

FIG. 4 best illustrates an embodiment wherein the wrist rest 100 is reversibly attached to mouse pad 112 along a juncture area 110. The reversibly attached nature may include any number of fasteners like the tongue and groove as illustrated or other embodiments. As part of this embodiment there may be a formed interlocking attachment 172. It should be noted that a single molded feature or an irreversible attachment as by gluing or sonic welding falls within parameters for joining the disparate parts.

FIGS. 5, 6 and 7 most clearly depict the integral assembly of wrist rest 100 and mouse pad 112. Moreover, the aforementioned drawings show the relative heights of wrist rest 100 in relation to mouse pad 112 along juncture area 110 and under juncture area 114. FIG. 7 shows the relative height of the mouse pad 112 and wrist rest 100 in this conformation.

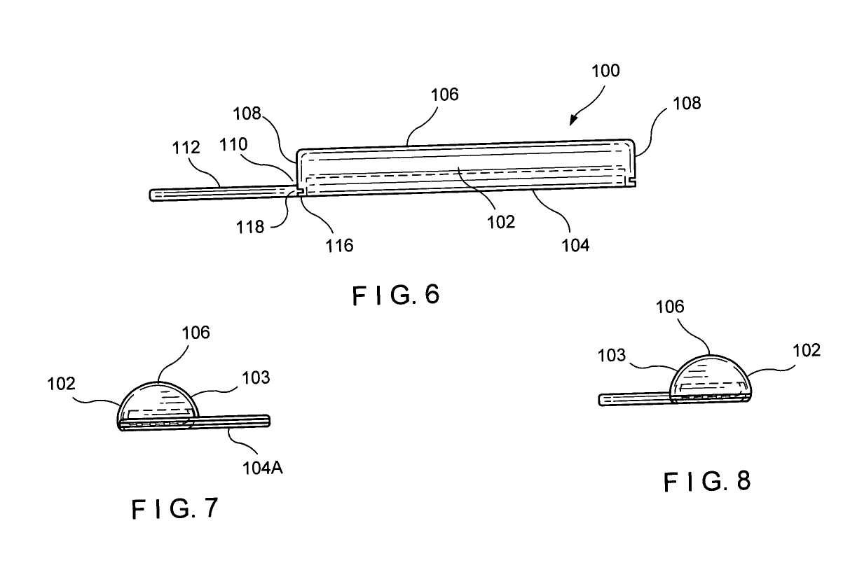

FIGS. 6 and 8 exemplify an alternate embodiment where mouse pad 112 is a separate piece from wrist rest 100 and fits therein as by an attachment means 166. For example an attachment means may be fashioned from an underlying attachment lip 116 and an overlying attachment lip 118 where one side has Velcro weave and the other has attaching hooks. FIG. 8 shows the relative heights and attachments of wrist rest 100 and mouse pad 112. FIGS. 7 and 8 not only show the conformation of wrist rest 100 but also the disposition of back of wrist rest 103 and top of 106.

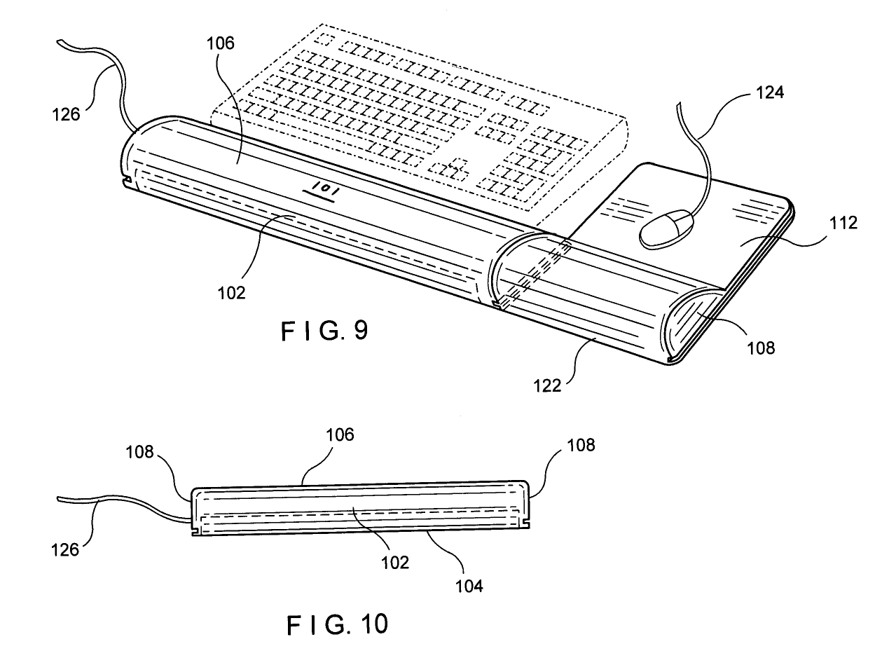

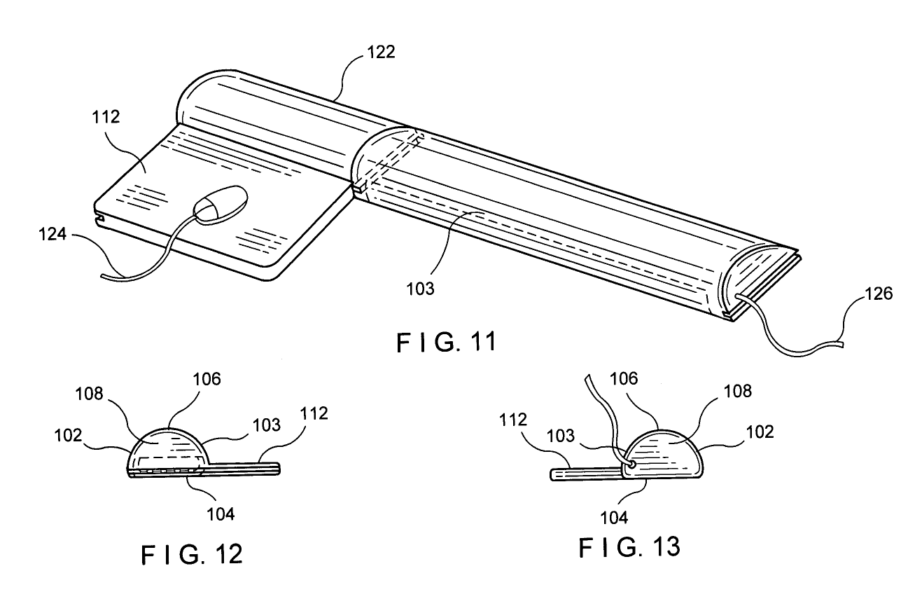

FIG. 9 depicts yet another embodiment wherein wrist rest 100 is substantially dimensionally the same length as the keyboard and mouse pad. Again it is understood that cradle base 128 may either be integral or constructed from disparate parts. To this end wrist rest 100 overlays both keyboard and mouse pad 112. A power connection means 126 is disposed so that a low voltage is provided to power to wrist rest 100 and its accessories. FIGS. 10 and 11 show the upstanding wrist rest 100 that overlays both keyboard and mouse pad 112, with FIG. 11, being further constructed as a two piece construction with attachment site 172 utilized but not illustrated. FIG. 11 shows a construction of wrist rest 100 from at least of two pieces. The second piece being derived from the communication with mouse pad 112. FIGS. 9 and 11 show the ability of the mouse pad 112 to be reversibly attached to either the right hand side and still communicate with a personal computer through mouse connection wire 124.

While FIG. 12 shows the assembly of wrist rest 100 and mouse pad 112 as a single component, FIG. 13 shows the assembly as from at least two pieces with an underlying/overlying lip 116/118 and an overlying lip attaching one to the other. It should be noted that it is intended that all parts of the assembly of this invention will have attachment means 116/118 on both sides.

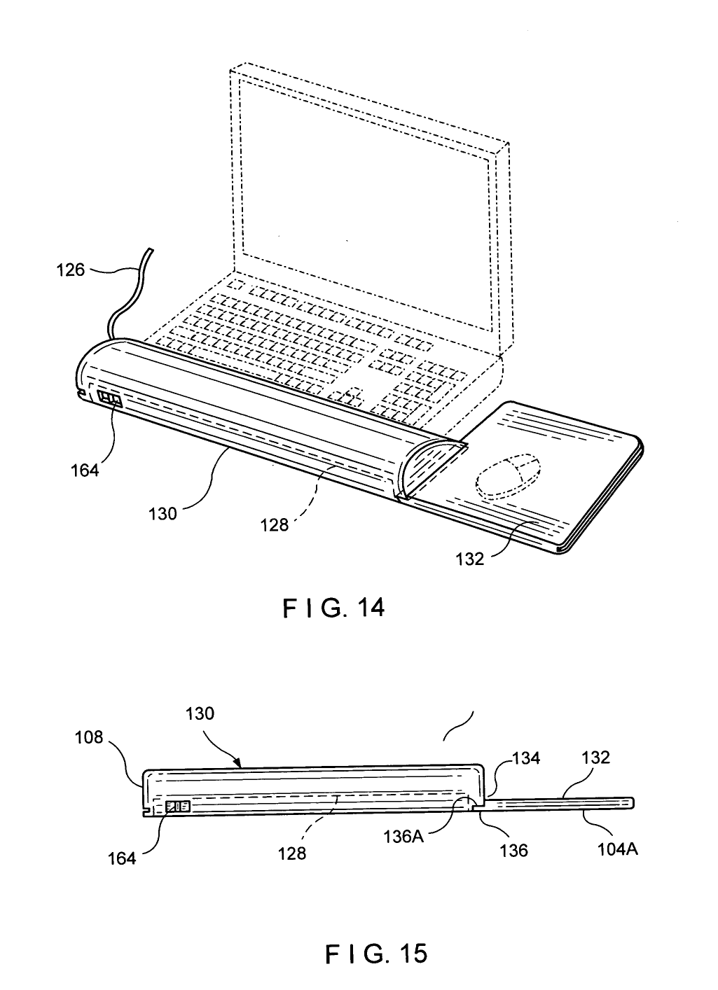

FIG. 14 illustrates that wrist rest 100 can be adapted to be used with a laptop configured personal computer so that wrist rest for a laptop 130 spans the keyboard and would provide a platform for a mouse by providing a mouse pad 132. Moreover, set out in dotted lines is a power connecting means 126 and an on off switch 164, which is operatively connected to a vibrating motor to create vibration to the users wrists and hands, a heating element for heat to the user or enough low voltage to power an air purifier, fan or the like, all being enumerated below.

Power source 228 in accordance with FIGS. 33 and 34 may be preferably derived from a low voltage power source remote from wrist rest 100. As an alternate embodiment power source 228 may be in close proximity to wrist rest 100 as by providing a battery compartment. As alternate embodiments, a voltage from a power source 228, may be introduced to wrist rest 100 by either embedding or otherwise running wires on or through cradle base 128. Power from a power source 228 may be derived from a USB connection, a battery, radio frequency source or any low voltage source. Other low voltage alternatives may be derived from infra red and “Blue Tooth” technology related sources. It is preferred that the voltage herein should be from about 0.5 volts to about 12 volts. Power may be provided by any of the aforementioned sources including a stand alone source or an adapter. A means to regulate the voltage from power source 228 may be as simple as rocker switches 152 and 164 or as complex as a software program and screen controlled graphic displays via an integrated circuit and personal computer in operative communication by connection with USB, infra red, or radio frequency modalities.

FIG. 15 shows wrist rest 100, cradle base 128, with an integral configuration connecting integral mouse pad attachment area 134, of mouse pad 132 as well as the positioning of on/off switch 164, said on/off switch 164 for accessories like a heater, vibrator, air purifier, cup holder, fan, personal radio, pumping device for a bladder, and or light.

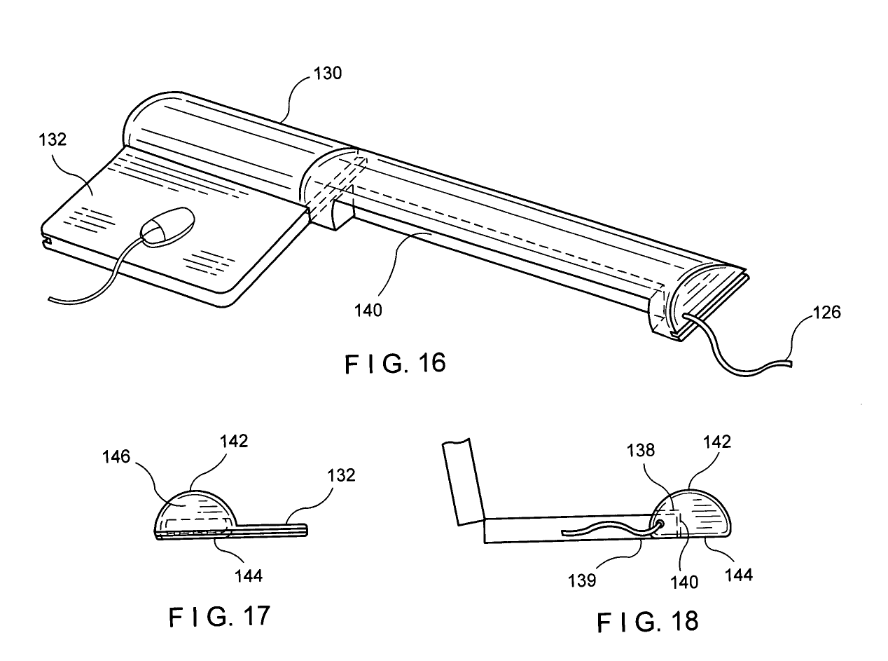

FIG. 16 shows wrist rest 100 for a laptop with underlying attachment sites 136 and 136A as an embodiment for insuring that wrist rest 100 remains in operative communication with a laptop computer. FIG. 17 shows wrist rest 100 in operative communication with a laptop personal computer, whereby said operative communication is achieved by mating the laptop within an L-shaped cutouts 138 and 140 mating with a laptop surface 139. FIG. 18 shows the L-shaped cutouts 138 and 140 for conjoining with the other operative elements of a laptop. Both figures illustrate top of wrist rest 142, bottom of wrist rest 144, and side of wrist rest 146, in relation to the laptop (FIG. 18) and in the relationship of the mouse pad.

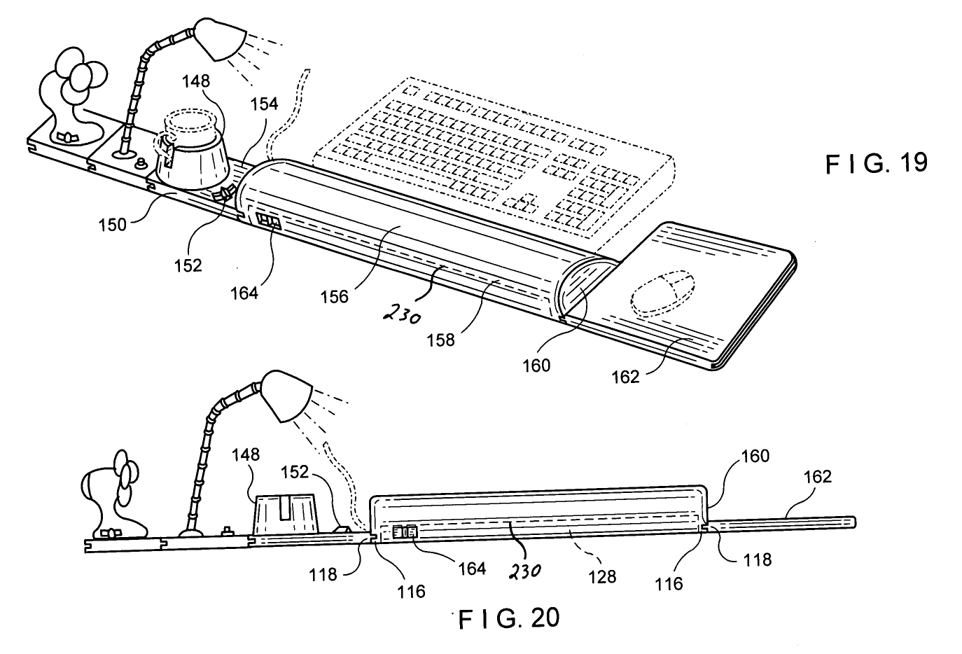

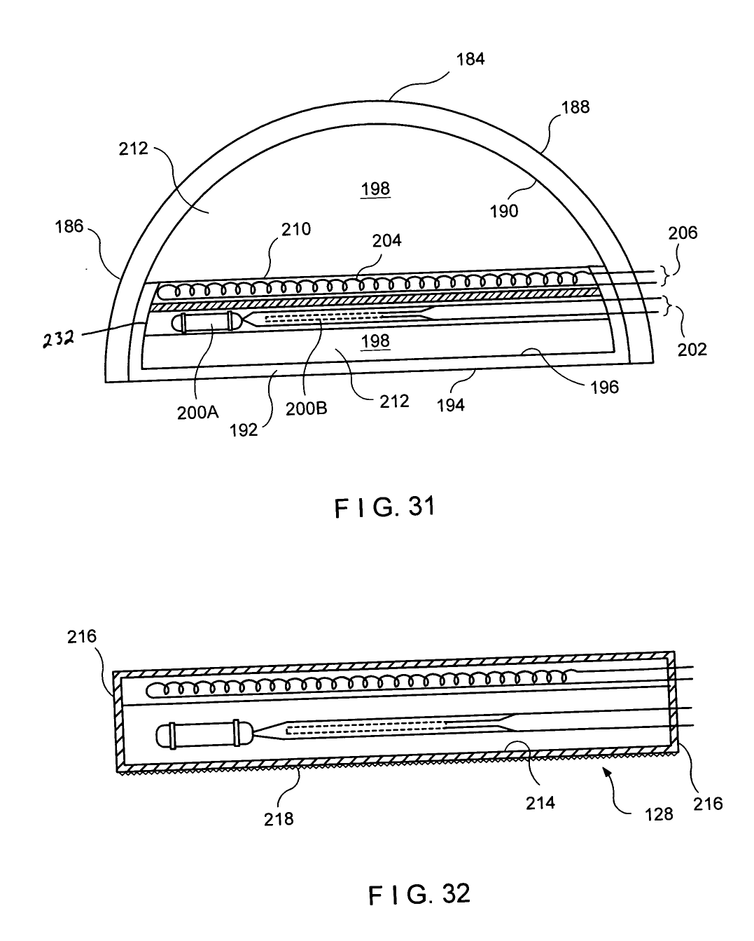

FIG. 19 shows wrist rest 100 with full accessory modes integrally attached. A cup holder base 150 may be operatively substituted for any number of structural support accessories like a book rest, typing stand, catch-all for supplies. In one embodiment cup-holder 148 provides an on/off switch 152, which may turn a heating element in cup-holder 148 or base 150 into an on or off condition. As shown hereinbelow in FIG. 31 an embodiment of the wiring and utility is depicted. In this FIG. 19, mouse pad 162 is joined either by an attachment means or as shown through integral mouse pad area 160. In addition, switches 152 and 164 are placed to provide the user with selective power to the main and accessory units. Top of wrist rest 156, and front of wrist rest 158, provides a vantage point for the user to control, utilize and enjoy various attachments.

FIG. 20 shows placement of switches 152 and 164 within or withon cradle base 128 and relative heights of the total assembly including cup-holder 148, wrist rest 100 and mouse pad 162. It is the height of wrist rest 100 that is of special moment. Given the height of from about 1 inch to about 4 inches the user's wrist is supported unlike other dimensional configurations, of the prior art where the wrist overlaps the rest. Moreover, the central idea is make the wrist rest fairly immovable so that whether there is a cup of coffee in cup holder 148 or proper typing posture and conformation, the objective is achieved. To this end, non-skid base member bottom 218 of FIG. 31.

As an alternate embodiment, it should be noted that a control means 164 may be operatively interposed as illustrated by FIGS. 19, 20 and 21. The control means may be screen and/or touch screen actuated. The aforementioned modality may be achieved by connection by USB, infra red, radio frequency or other digital communication. A window, much like the window provided for audio adjustment may vest the user with controls to vary the magnitude and tempo of the vibration, and vary the amount of heat transmitted to the user's wrist. The modality may be controlled by a software plug and play and transparently layer on any resident operating system. For this embodiment, an integrated circuit would be operatively interposed as a controller for the unit and to send data responsive to user input to control various functions (ie vibration, heat, power).

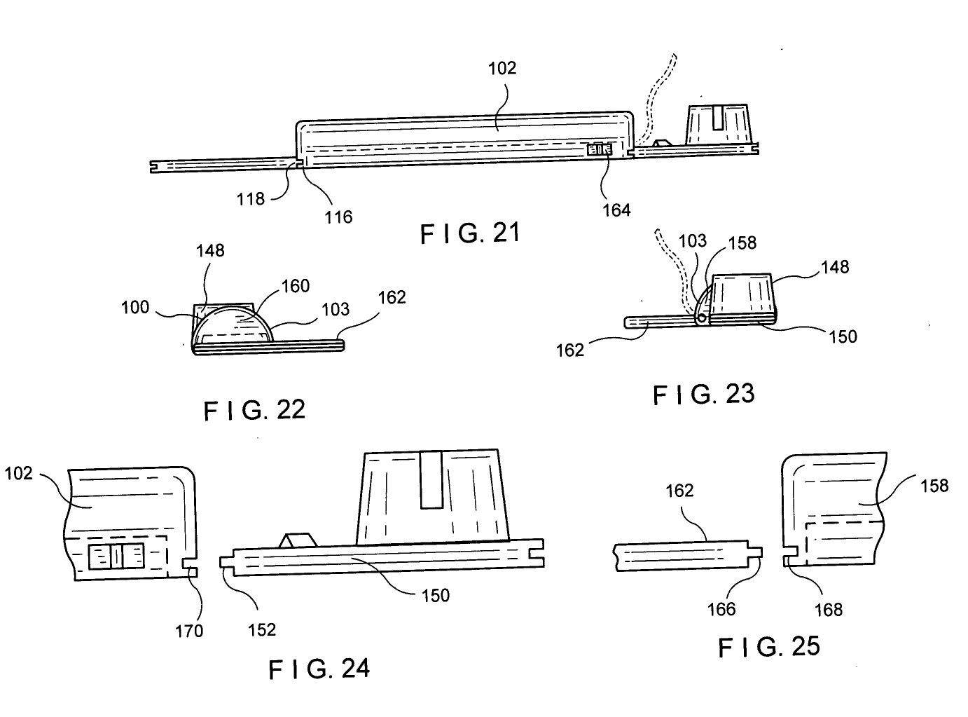

FIG. 21 clearly displays the flexibility of the design, showing a reversibly attachable mouse pad 162, wrist rest 100, cup-holder 148. It should be noted that given the attachable nature of the accessories, the user can mix and match the accessories, utilizing one or more accessories therefore. For example the user can interpose a cup-holder along with the wrist rest or the cup-holder, an air purifier, light and or a fan.

FIGS. 22 and 23 show the relative heights of the disparate parts from both sides and particularly mouse pad 162, front 102, elongated member 101 or wrist rest 100 on one side and accessory cup-holder base 150 of cup-holder 148. FIG. 24 depicts an exploded view of one embodiment of the attachment means generally 166, 168, 170 and 172. It is understood that the specific embodiment is for demonstrative purposes only and the actual closure or attachment means may vary in geometry and design. FIG. 24 basically sets out the electrical connecting relationship between separate pieces of rest 100 and accessory 152. As shown in FIG. 24 the polarity may be connected as positive to positive for parallel connections, and positive to negative for series connections. Notwithstanding the foregoing, it is the potential utility that dictates the polarity. As the preferred embodiment attachment sites 166/168 may be fitted with contacts so that an inclusion of an element results in the flow of power to that element. The attachment means 166-170 or 116-118 may be of a multitude of configurations so as to allow the disparate parts to snap together, interlock, or otherwise reversibly fasten one to the other.

Turning to the FIGS. 6, 8, 13, 16, 18, 19, 21, 23, 27, 29, there are many different ways to plug the disparate parts together for example FIGS. 6 and 24 show but two ways. The first way may be with an underlying lip and Velcro on both sides, while in FIG. 24 the attachment is the one which is similar to use in toys (inter-connect like model railroads, model raceways and slot cars).

FIGS. 26-30 show wrist rest 100 with a mouse pad and air purifier 174 along with the power leads in dotted lines. Whether it is an ionizer, light or fan as best viewed by FIGS. 19-20, the low voltage is delivered by embedded wires 230. Again, accessories can be either powered or not, as in the case of a book rest or typing stand.

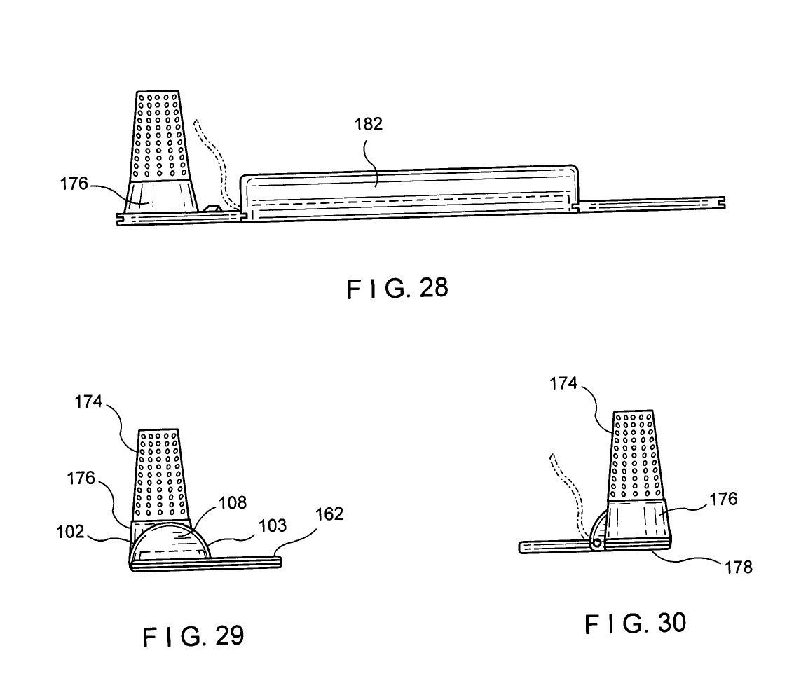

FIGS. 26 and 27 show air purifier in relation to the front surface of the wrist rest 100 in an actuated and deactivated condition—the assemblies as integral and alternately as snapped together—reversibly attached FIGS. 28 and 29 show relative configurations from the side as both integral and attached as parts.

FIGS. 30 and 31 show what is contained within wrist rest 100 with and without a separate cradle base 128. FIG. 30 shows an embodiment wherein a polymer skin 188 and 190 provides a continuous front/back 186, top 184, bottom 194. Outer and inner walls 188 and 190 may be constructed from a hydrophobic impermeable polymer and provides a cavity 198. Within cavity 198 a series of malleable and conformable materials may be operatively instilled. For example, a gel, sand, polymer balls, a copolymer, wooden pieces, metal bearings, and many other materials may be conformable. For example, a gel with a differential hardness and density may be preferably employed by changing the ratio of co-polymer to oil or water to carboxymethylcellulose. By example, a gel, which is a mixture of carboxymethylcellulose, water and a preservative in the following percentages by weight would yield an acceptable gel, with the relative hardness/softness/deformability dependent on the amount of carboxymethylcellulose in relation to water. It should be noted that a preservative or anti-bacterial substrate is most preferred since the condensation or moisture from the user's skin would act as a substrate to seed an otherwise friendly surface for growth of bacterial or other unacceptable organisms. The gel or other material should be a material that is conformable to the user's wrist and hand, of sufficient structural integrity to mold to and support the user's wrist occupying substantially all of said cavity and the closure thereof results in a conformable area that is substantially higher than said keyboard and mouse pad. A skin or outer surface 186, said material being deformable and conformable to the users wrist may contain and support a gel or other material. Elastomeric polymers, cross linked co-polymers with conformable and malleable characteristics, and elastomeric polymers combined with a paraffinic oil of low volatility may be operatively substituted without reducing the utility thereof.

As stated herein, the resulting wrist rest 100 is conformable to the user's hand and wrist with the uppermost margin being gently rounded or loaf-shaped. This raised pillow more fully supports the wrist and hand without canting the wrist and hand at an unnatural angle.

A bladder may be operatively substituted for all or part of the gel 212. As partial substitution by a bladder the result may be achieved in reducing weight. Total substitution yields a medium where the relative softness (conformable aspect) is infinitely adjustable. The relative hardness/softness is a function of the bladder being in a fully inflated or relatively deflated condition. While a flexible bladder is one embodiment, a sealed tube may be an alternate embodiment to provide not only structural rigidity but also reduce the amount of gel and therefore the weight of the rest itself.

By the illustrations of FIG. 32, cradle 128 may be constructed as a disparate unit having a base 214, sides 216 and ends 108. Cradle 128 may be integrally molded into wrist rest 100. Notwithstanding its utilization, cradle 128 may be fashioned from a rigid polymer like polyvinylchloride, a light metal like aluminum, wood or various combinations of each.

With regard to FIGS. 31-35 a vibrator or motor assembly 200 receives power from wires 206 and 202, said vibrator or motor assembly yielding from about 1000 rpms to about 100,000 rpms. Vibrator 200 may be of any practical shape and in one rounded embodiment is from about 10 mm to about 20 mm in diameter. It should be noted from FIG. 32 that vibrator 200 and heating coil

It is a general utility of the instant invention to provide as set out in FIGS. 24, 30 and 31 illustrates the novel wiring of rest 100. To this end cradle 128 of rest 100 is designed to incorporate leads and contacts so that the operative introduction of a separate piece, as be example, cup holder 148 will also effectuate the delivery of power to the accessory. Accessories for this area may be a fan, an air purifier 174, a heated cup holder, or an auxiliary light. For this end switch 152 may be operatively interposed within cradle 128. Simply, attachment means 116-118 and 166-172 not only join disparate section but also act as a transfer means, so that power flows, therethrough. Wrist rest 100 may be slightly warmed as heating strip 204 in accordance with FIG. 31 supplies sufficient low voltage power to effectuate this end. The voltage may be derived as DC or AC power. Given the placement of a structural element of flat base member 178 and air purifier base 176, FIG. 26 shows the flexibility of the present system for right or left hand use. FIGS. 27 and 28 shows a configuration that provides front 180 and rear of wrist rest 100.

A polymer skin, which is preferred, can be of smooth, crinkled, spongy, or other construction. In one embodiment in accordance, with FIG. 34, it should be noted that the top 184 is of a rounded conformation, while the bottom 194 is essentially flat. In one configuration there may be an essentially loaf-shape to wrist rest 100.

As another embodiment as illustrated by FIG. 33 appertains to a flexible sheath 224 constructed from a natural or polymer fiber cloth adapted to retain a heating coil 220 and a connection 228 to a power source. Flexible sheath 224 may be removed, washed and provides gentle heat to the user's wrists and hand. It is preferred that not only is the sheath removable and washable, but also hypoallergenic. In FIG. 34 a non-skid base 218, fashioned from a non-skid or sticky polymer, resides below bottom side 194 of cradle 128. Non-skid base 218 adds further stability to the assemblage and retains wrist rest 100 in an essentially immovable condition in communication with a keyboard and mouse pad. Inside chamber 196 of wrist rest 100 may be of a flattened configuration when in communication with cradle base 128.

FIG. 32 illustrates a preferred approach for bundling a vibratory unit as vibrator 200 with heating coil 204 in combination with cradle 138 so that a disparate sub-unit arises. As a result, upon failure of heating element or vibrator, a separate cradle with both may be operatively substituted with the original wrist rest 100.

Depicted by FIG. 33 is rest 100 with a covering 224, said covering retaining heating element 204, and over-wrapping wrist rest 100. Heating element 204 may be disposed in a number ways including weaving into the fabric. Another way is to utilize a heating tape or polymer foil. Inner cavity 198 retains gel 212, and bottom cradle retain wrist rest 100 thereon. Vibrator element 200A when actuated directs vibration upwards and into gel 212. It should be understood from the drawing that each vibratory unit 200 is disposed in a longitudinal relation one to the other so that there are several vibrators laid out along the length of wrist rest 100. The same holds true for heating element 204 and leads positive and negative leads 222.

Returning to FIGS. 33 and 34, an embodiment wherein cradle or base 192 supports a gel 212 elongated member 101 and substantially filling cavity 198 formed from the inner wall 190 of side wall 188 which cooperatively form a skin. A series of leads 222 and 202 supply power to the embedded vibrator 200 and to embedded heating element 204. As an alternate embodiment, an over-wrapped heating element 204 woven or otherwise formed from a preferably, removable, washable, and hypoallergenic material with heating elements woven or placed therein, is separated by a membrane or skin 210. FIGS. 31 and 33 show one embodiment where the vibrator and heating element is disposed within the inner cavity of 198 of elongated member 101. Placement may be achieved by the introduction of a pre-assembled series of parts as in FIGS. 31 and 33 where the vibrator 200 and the heating element 220 may be contained within cartridge 232, said cartridge being implanted within gel 212 of elongated member 101. FIGS. 31 and 32 depict an embodiment wherein vibrator 200 and heating element 204 are retained within cartridge 232, said cartridge being energized by leads 202. FIGS. 33 and 34 show an alternate preferred embodiment wherein vibrator 200 is either contained within cartridge 232 as in FIG. 33 or within or withon cradle 128 as in FIG. 34. In the aforementioned configurations, heating element 220 over-wraps elongated member 101. FIG. 34 depicts non-slip base 218, which may be extended to at least cover wrist rest 100 at the minimum point, and may extend under the keyboard or laptop to prevent unwanted movement.

FIG. 35 provides a depiction of a preferred embodiment wherein there is a plurality of footings 226. Each footing is preferably formed from a thermoplastic polymer, said polymer having a semi-rigid or compressible structure to support wrist rest 100 while isolating and absorbing vibratory energy from vibrator unit 200 the energy which would be directed downward and lost is directed upward and to the user. A byproduct of the isolation and vibration reduction is a concomitant reduction in overall noise. Without footings 226 the vibrations directed downward to the desktop would be amplified and a disagreeable noise would emanate therefrom. It is most preferred that footings 226 are shaped as individual strips so that there is a space between each footing, the space breaking up the unimpeded transmission of the vibration.

While the foregoing embodiments of the invention have been set forth in considerable detail for the purposes of making a complete disclosure of the invention, it will be apparent to those of skill in the art that numerous changes may be made in such details without departing from the spirit and the principles of the invention.

We claim:

1. A wrist rest for a keyboard and mouse pad comprising:
an elongated member conformable to a the wrist and hand of a user;
an attachment means located on one end of said elongated member and a second attachment means located on the opposite end effective to reversibly affix at least one accessory or attachment; and
a means to transmit power, from a power source to at least part of said elongated member.

2. An elongated member as described in claim 1 wherein said elongated member is substantially the same length as a keyboard and mouse pad.

3. An elongated member as described in claim 1 wherein said elongated member is from about 19 inches to about 30 inches long and from about 3 to about 6 inches wide, and from about 1 inch to about 4 inches high.

4. A conformable material as described in claim 1 chosen from the group consisting of gels, polymer balls, charcoal spheres, wood pellets, sand, sterilized organic material, open and closed cell foams, sponges, vitreous spheres, metallic spheres, bladders, and combinations thereof.

5. A conformable material as described in claim 1 wherein said material is a gel chosen from the group consisting naturally occurring polymers and water, co-polymers and oils, cross-linked co-polymers and combinations thereof.

6. A conformable material as described in claim 1 wherein said gel is carboxymethylcellulose, a preservative and water.

7. An accessory or attachment as described in claim 1 wherein said accessory or attachment is a heating element.

8. A heating element as described in claim 6 wherein said heating element is embedded with said elongated member.

9. A heating element as described in claim 6 wherein said heating element is over-wrapped around said elongated member.

10. A heating element as described in claim 6 wherein said heating element is a polymer tape or a cloth with a woven heating element.

11. An accessory or attachment as described in claim 1 wherein said accessory or attachment is chosen from the group consisting of an extension, a cup holder, a fan, a light, an ionizer and combinations thereof.

12. A power source as described in claim 1 wherein said power source is chosen from the group consisting of power from a USB port, batteries, infra red transmission, hardwired connections, Blue Tooth transmission, and combinations thereof.

13. A power source as described in claim 1 wherein said power source is from 0.5 Volts to 12 Volts.

14. A wrist rest for a keyboard and mouse pad comprising:
an elongated member conformable to a the wrist and hand of a user;
a cradle base adapted to receive said elongated member;
an attachment means located on one end of said elongated member and a second attachment means located on the opposite end effective to reversibly affix at least one accessory or attachment;
at least two leads to transmit power, from a power source to at least part of said elongated member; and
an on/off switch therefore.

15. An elongated member as described in claim 14 wherein said elongated member is substantially the same length as a keyboard and mouse pad.

16. A conformable material as described in claim 14 chosen from the group consisting of gels, polymer balls, charcoal spheres, wood pellets, sand, sterilized organic material, open and closed cell foams, sponges, vitreous spheres, metallic spheres, bladders, and combinations thereof.

17. A conformable material as described in claim 14 wherein said material is a gel chosen from the group consisting naturally occurring polymers and water, co-polymers and oils, cross-linked co-polymers and combinations thereof.

18. A conformable material as described in claim 14 wherein said gel is carboxymethylcellulose, a preservative and water.

19. An elongated member as described in claim 14 wherein said elongated member is substantially the same length as a keyboard an mouse pad.

20. A conformable material as described in claim 14 chosen from the group consisting of gels, polymer balls, charcoal spheres, wood pellets, sand, sterilized organic material, open and closed cell foams, sponges, vitreous spheres, metallic spheres, bladders, and combinations thereof.

21. A conformable material as described in claim 14 wherein said material is a gel chosen from the group consisting naturally occurring polymers and water, co-polymers and oils, cross-linked co-polymers and combinations thereof.

22. A conformable material as described in claim 14 wherein said gel is carboxymethylcellulose, a preservative and water.

23. An accessory or attachment as described in claim 14 wherein said accessory or attachment is a heating element.

24. An elongated member as described in claim 14 wherein said elongated member is substantially the same length as a keyboard and mouse pad.

25. A wrist rest for a keyboard and mouse pad comprising:
a first member having a sufficient number of sides to create a open end on one side, a closed end on the other and a cavity therein creating a closure;
a material that is conformable to the user's of sufficient structural integrity to mold to and support the user's wrist occupying substantially all of said cavity and the closure thereof results in a conformable area that is substantially higher than said keyboard and mouse pad;
an attachment area so that said rest may be reversibly connected to a mouse pad;
an attachment means effective to reversibly connect at least one accessory thereto;
a power source to supply power to at least a positive and negative lead;
an on/off switch to provide power and to withdraw power to said at least one accessory; and
a means to regulate power to said at least one accessory by communicating with a personal computer.

26. A conformable material as described in claim 25 chosen from the group consisting of gels, polymer balls, charcoal spheres, wood pellets, sand, sterilized organic material, open and closed cell foams, sponges, vitreous spheres, metallic spheres, bladders, and combinations thereof.

27. A conformable material as described in claim 25 wherein said material is a gel chosen from the group consisting naturally occurring polymers and water, co-polymers and oils, cross-linked co-polymers and combinations thereof.

28. A conformable material as described in claim 25 wherein said gel is carboxymethylcellulose, a preservative and water.

29. An accessory or attachment as described in claim 25 wherein said accessory or attachment is a heating element.

30. A heating element as described in claim 29 wherein said heating element is embedded with said elongated member.

31. A heating element as described in claim 29 wherein said heating element is over-wrapped around said elongated member.

32. An accessory or attachment as described in claim 29 where said accessory is a vibrator unit.

33. An accessory as described in claim 32 where said vibrator unit is embedded into said elongated member.

34. A heating element as described in claim 29 wherein said heating element is a polymer tape or a cloth with a woven heating element.

35. An accessory or attachment as described in claim 25 wherein said accessory or attachment is chosen from the group consisting of an extension, a cup holder, a fan, a light, an ionizer and combinations thereof.

35. A power source as described in claim 25 wherein said power source is chosen from the group consisting of power from a USB port, batteries, infra red transmission, hardwired connections, Blue Tooth transmission, and combinations thereof.

36. A heating element as described in claim 29 wherein said heating element is embedded with said elongated member.

37. A heating element as described in claim 29 wherein said heating element is over-wrapped around said elongated member.

38. A heating element as described in claim 29 wherein said heating element is a polymer tape or a cloth with a woven heating element.

39. An elongated member in communication with a cradle base so that said elongated member is supported thereby.

40. A cradle base as described in claim 39 wherein said cradle base is separate and composed of a base, opposing sides, opposing ends and adapted to receive leads and said elongated member.

41. An accessory as described in claim 1 wherein said accessory is structural.

42. A means to regulate power as described in claim 25 wherein said means is a screen controlled software program.

43. At least one accessory as described in claim 25 wherein said accessory is contained within a cartridge, said accessory being a heating element or a vibrator or a combination thereof.

44. An attachment means as described in claim 1, wherein said attachment reversibly joins one or more sections and provides power thereto.

45. A woven element comprising a removable, washable and hypoallergenic and essentially over-wrapping said wrist rest.
